(19) United States
(12) Patent Application Publication
(10) Pub. No.: US 2025/0222696 A1
(43) Pub. Date: Jul. 10, 2025

(54) LIQUID EJECTION APPARATUS AND METHOD OF CONTROLLING LIQUID EJECTION APPARATUS

(71) Applicant: CANON KABUSHIKI KAISHA, Tokyo (JP)

(72) Inventor: TAKUYA HAMADA, Kanagawa (JP)

(21) Appl. No.: 18/954,109

(22) Filed: Nov. 20, 2024

(30) Foreign Application Priority Data
Jan. 4, 2024 (JP) 2024-000169

(51) Int. Cl. B41J 2/165; B41J 2/175; B41J 2/18

(52) U.S. Cl. CPC B41J 2/16538; B41J 2/1652; B41J 2/17596; B41J 2/18; B41P 2235/20

(57) ABSTRACT

A liquid ejection apparatus includes: a liquid ejection head including an ejection port configured to eject a liquid and a pressure chamber communicating with the ejection port; a circulation unit configured to circulate the liquid in the liquid ejection head so as to pass through the; a recovery unit configured to perform a recovery operation of the liquid ejection head at a circulation flow velocity slower than a circulation flow velocity of the circulation unit in a case where the liquid ejection head prints an image on a printing medium; and a control unit configured to control preliminary ejection to eject the liquid that is not used for the printing from the ejection port in parallel with the recovery operation by the recovery unit.

### BACKGROUND OF THE INVENTION

### Field of the Invention

The present disclosure relates to a liquid ejection apparatus and a method of controlling the liquid ejection apparatus.

### Description of the Related Art

In ink jet printing apparatuses, there has been known a configuration in which an ink is circulated so as to pass through a channel communicating with each of ejection ports arrayed densely and a pressure chamber corresponding to the ejection port, and thus a rise in the viscosity of the ink in the ejection ports is suppressed (Japanese Patent Laid-Open No. 2017-124617, which is hereinafter referred to as PTL 1). In PTL 1, a pressure difference between two pressure adjustment mechanisms is used to generate a flow of an ink so as to pass through a pressure chamber.

Additionally, in the ink jet printing apparatuses, in general, a recovery operation is performed by wiping an ejection port array surface of a printing head by a wiper blade and the like. In this process, so-called color mixture in which the inks attached on the ejection port array surface invade the ejection port and are mixed may occur, or a foreign substance may be pushed into the ejection port. Usually, the color mixture and the foreign substance as described above are removed by preliminary ejection or a suction operation.

In this case, in a configuration in which the ink in the ejection port is circulated as described in PTL 1, in a case where the recovery operation of the ejection port array surface is performed while keeping the ink in circulation in the ejection port, there is a possibility that the color-mixed ink and the foreign substance in the ejection port invade deep into a circulation channel and cannot be removed. Japanese Patent Laid-Open No. 2016-199021 (hereinafter, referred to as PTL 2) describes a configuration in which a circulation pump is stopped in a case where the recovery operation of the ejection port array surface is executed.

However, even in a case where the circulation pump is stopped in a case where the recovery operation is executed as PTL 2, in some cases, a time lag may occur until the flow velocity of the ink passing through the ejection port completely stops. For example, in a case where the flow of the ink is generated by the pressure difference between the pressure adjustment mechanisms as PTL 1, a flow of the ink may occur in the circulation channel including the inside of the ejection port until the pressure difference is eliminated. For this reason, for example, in a case where the recovery of the ejection port array surface is executed after circulation driving is stopped after the printing operation ends, if the time from the end of the printing operation to the start of the recovery operation is short, the recovery operation is executed without stopping the circulation flow velocity in the ejection port. In this case, there is a possibility that the color-mixed ink or the foreign substance invades deep into the channel with the circulation flow velocity and cannot be removed by the preliminary ejection or the suction operation. As a result, there is a possibility that abnormal tonality in a printed image, deviated landing of an ink droplet, and a defective ejection nozzle occur.

On the other hand, in a case where the circulation driving is stopped after the printing operation ends, and additionally waiting time until the circulation flow velocity is stopped is provided, consequently, there is a possibility of a delay in starting the recovery operation, and the productivity is reduced.

### SUMMARY OF THE INVENTION

A liquid ejection apparatus according to an aspect of the present disclosure includes: a liquid ejection head including an ejection port configured to eject a liquid and a pressure chamber communicating with the ejection port; a circulation unit configured to circulate the liquid in the liquid ejection head so as to pass through the pressure chamber; a recovery unit configured to perform a recovery operation of the liquid ejection head at a circulation flow velocity slower than a circulation flow velocity of the circulation unit in a case where the liquid ejection head prints an image on a printing medium; and a control unit configured to control preliminary ejection to eject the liquid that is not used for the printing from the ejection port in parallel with the recovery operation by the recovery unit.

Further features of the present invention will become apparent from the following description of exemplary embodiments with reference to the attached drawings.

### BRIEF DESCRIPTION OF THE DRAWINGS

FIG. 1 is a diagram illustrating appearance of a printing apparatus;

FIG. 2 is a block diagram illustrating a configuration of a printing control system in a printing apparatus;

FIG. 3 is a diagram describing a configuration of a printing head;

FIG. 4 is a schematic view of a recovery unit;

FIG. 5 is a diagram schematically illustrating the configuration of the printing head;

FIG. 6 is a diagram illustrating a configuration of an ejection port and a channel and a flow of an ink;

FIG. 7 is a schematic view of a bottom surface of a chip;

FIG. 8 is a graph illustrating an ink flow velocity of an in-nozzle circulation channel with respect to an elapsed time;

FIGS. 9A and 9B are diagrams schematically illustrating wiping and a preliminary ejection operation;

FIGS. 10A and 10B are diagrams illustrating a recovery operation and preliminary ejection execution period;

FIG. 11 is a diagram illustrating another example of the recovery operation and preliminary ejection execution period;

FIG. 12 is a diagram illustrating a flowchart in a case of control to execute the preliminary ejection;

FIG. 13 is a diagram illustrating a required flow velocity table;

FIG. 14 is a diagram illustrating a flow velocity prediction table;

FIG. 15 is a flowchart illustrating processing of details of S1208;

FIG. 16 is a diagram illustrating a secular change of the circulation flow velocity after a circulation driving pump is stopped;

FIG. 17 is a diagram illustrating a flowchart in a case of control to execute the preliminary ejection;

FIG. 18 is a flowchart illustrating details of S1710;

FIG. 19 is a diagram illustrating an example of a wiping area; and

FIG. 20 is a diagram describing control of a preliminary ejection amount of each nozzle according to a channel configuration of the nozzle.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the present embodiments are necessarily required for the means for solving the problems of the present disclosure. Note that, the same reference numerals are provided to the same constituents.

In the present specification, “printing” involves not only a case of forming significant information, such as a character and a graphic, and does not matter whether it is significant or insignificant. Additionally, “printing” widely indicates a case of forming an image, a design, a pattern, and the like on a printing medium or processing the medium regardless of whether it is visible to be visually sensed by a human. The “printing medium” indicates not only paper used in a common printing apparatus but also widely indicates something that can receive an ink such as cloth, a plastic film, a metal plate, glass, ceramics, wood material, and leather. The “ink” (also referred to as a “liquid”) should be construed widely as with the above-described definition of “printing”. Accordingly, the ink indicates a liquid that can be applied onto the printing medium for formation of an image, a design, a pattern, and the like, processing of the printing medium, or processing of the ink (for example, solidification or insolubilization of color material in the ink applied to the printing medium). Unless otherwise stated, a “nozzle” collectively indicates an ejection port, a liquid passage communicating with the ejection port, and an element generating energy used for ink ejection.

In general, resin and the like are added to the ink used in the ink jet printing apparatus for the improvement of the image quality and the fastness. The addition of the resin and the like is performed for the improvement of the color developability by the rising of the viscosity of the ink along with water evaporation and fixing the color material on the printing medium or for the improvement of the fastness by protecting the color material with a resin film. In this case, in a case where a smaller liquid droplet is ejected by densely arranging the ejection ports to improve the image quality, the thickening of the ink may occur in the ejection port due to the water evaporation. As a result, the ejection of the ink droplet is inhibited, a landing position of the ink droplet on the printing medium is deviated, and the defective ejection occurs; thus, deterioration of the image quality may be caused.

The ink jet printing apparatus of the present embodiment suppresses the thickening of the ink in the ejection port by circulating the ink so as to pass through the ejection port. In addition, an example in which entering of the color-mixed ink or the foreign substance into the channel during the recovery operation is suppressed while suppressing the reduction of the productivity in the above-described ink jet printing apparatus is described below specifically.

### FIRST EMBODIMENT

### Configuration of Liquid Ejection Apparatus

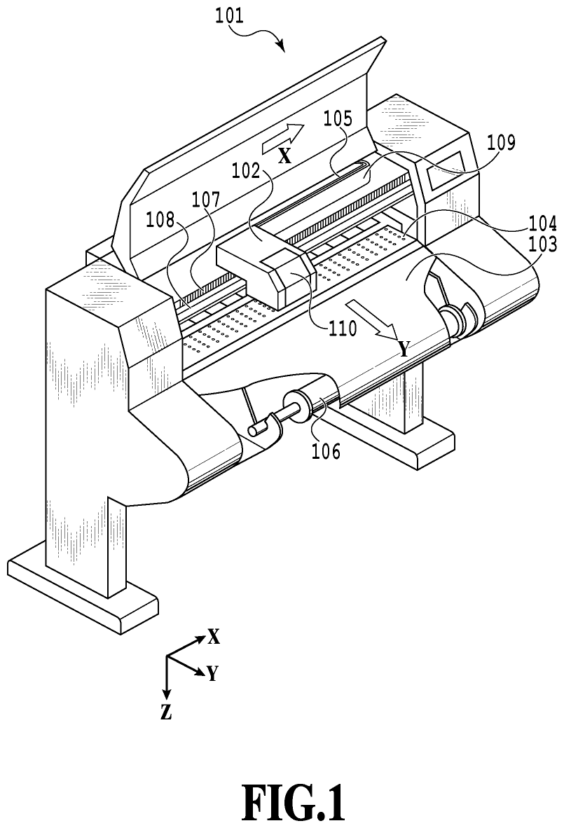

FIG. 1 is a diagram illustrating appearance of a liquid ejection apparatus according to the present embodiment. The liquid ejection apparatus of the present embodiment is an ink jet printing apparatus (hereinafter, also referred to as a printing apparatus, simply). A printing apparatus 101 of the present embodiment is a so-called serial scanning type printer. The printing apparatus 101 is an apparatus that prints an image by scanning a printing head 110, which is a liquid ejection head, in an X direction (a scanning direction) orthogonal to a Y direction (a conveyance direction) in which a printing medium 103 is conveyed.

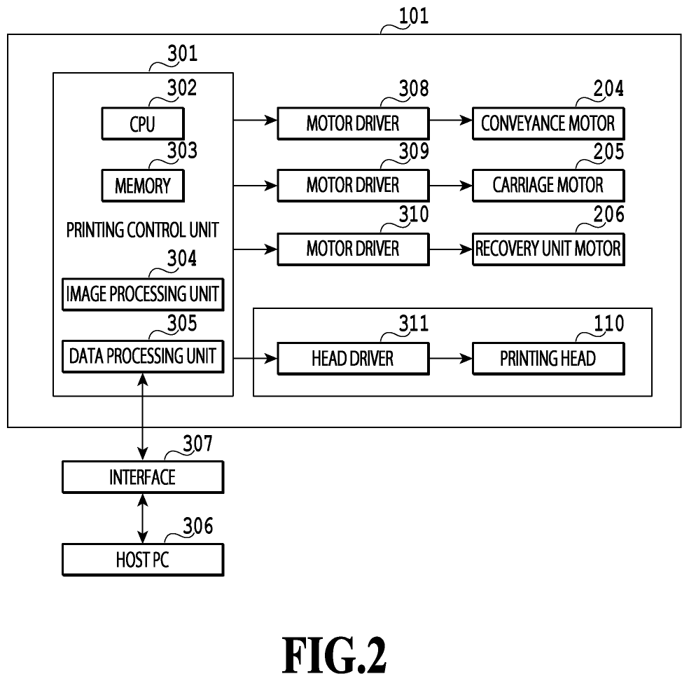

An overview of a configuration of the printing apparatus 101 and an operation in a case of printing is described with reference to FIG. 1. First, the printing medium 103 is conveyed in the Y direction by a conveyance roller driven via a gear by a conveyance motor 204 (FIG. 2) from a spooler 106 holding the printing medium 103. The fed printing medium 103 is pinched and conveyed by a feeding roller and a pinch roller and guided to a printing position on a platen 104 (a scanning region of the printing head 110). On the other hand, in a predetermined conveyance position, a carriage unit 102 is reciprocally scanned (reciprocally moved) in the X direction along a guide shaft 108 extending in the X direction by a carriage motor 205 (FIG. 2). The printing head 110 is mounted on the carriage unit 102. In addition, in this scanning process, in a timing based on a position signal obtained by an encoder 107, an ejection operation is performed from a nozzle (an ejection port) of the printing head 110, and printing at a constant bandwidth corresponding to an ejection port array range is performed. Thereafter, the printing medium 103 is conveyed, and additionally printing of the next bandwidth is performed. Thus, a configuration in which the conveyance of the printing medium 103 and the printing and scanning by the printing head 110 are performed alternately, and a desired image is printed on the printing medium 103 is applied.

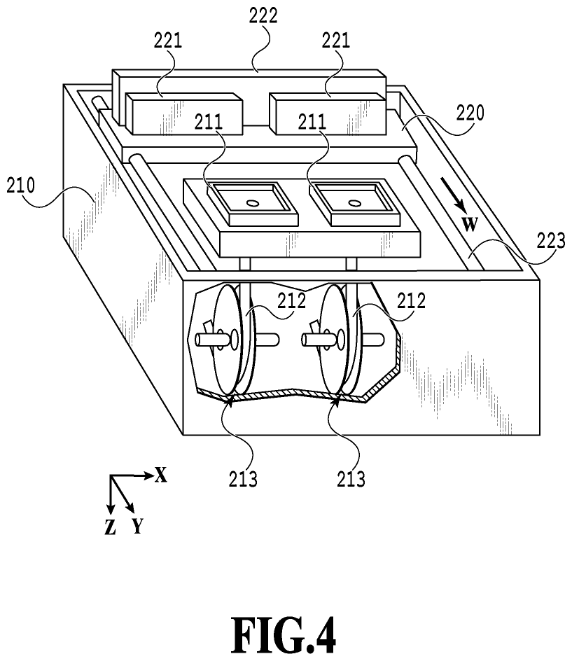

Note that, in a dormant state, a face surface of the printing head 110 is usually capped by a cap 211 equipped by a recovery unit 210 described later (FIG. 4). Therefore, the cap 211 is opened in advance to the printing, and the printing head 110 (the carriage unit 102) is switched to a scannable state. Thereafter, once data of one scanning is accumulated in a buffer, the carriage unit 102 is scanned by the carriage motor 205, and the printing operation as described above is performed.

Note that, it is possible to use a carriage belt (not illustrated) to transmit driving force from the carriage motor 205 to the carriage unit 102. However, instead of the carriage belt, for example, a device equipped with a leadscrew extending in the X direction and rotationally driven by the carriage motor 205 and an engagement unit provided to the carriage unit 102 and engaged with a groove of the leadscrew may be used. Thus, it is also possible to use another driving method.

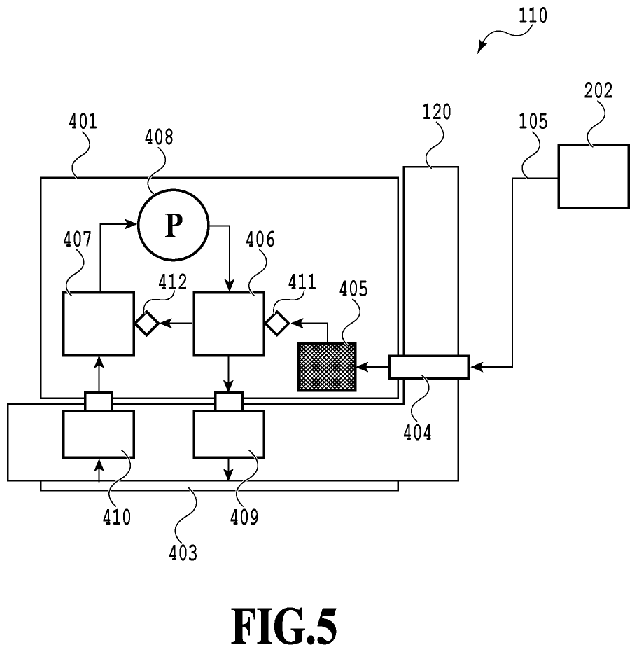

Additionally, the ink supplied to the printing head 110 is supplied by way of the carriage unit 102 by a supply tube 105 from an ink tank 202 (FIG. 5) mounted in a main body of the printing apparatus 101 or an external unit. The ink may be supplied to the printing head 110 from the ink tank 202 by using a pressurization unit. Alternatively, the ink may be supplied by capping an ejection port surface of the printing head 110 by using the cap 211 of the recovery unit 210 and sucking with application of a negative pressure to the inside of the cap by a suction pump 213 (FIG. 4).

Multiple printing heads 110 that can eject one or more colors of inks may be mounted on the carriage unit 102, and a mode in which a single printing head 110 that can eject multiple colors of inks is mounted on the carriage unit 102 may be applied. Additionally, a mode in which one or more printing heads 110 that can eject a single color of ink are mounted on the carriage unit 102 may be applied. Moreover, although a serial scanning type printer is described as an example in the present embodiment, a printing apparatus on which a full-line type printing head is mounted may be applied.

### Printing Control

FIG. 2 is a block diagram illustrating a configuration of a printing control system in the printing apparatus 101 illustrated in FIG. 1.

The printing apparatus 101 is connected to a data supply apparatus such as a host computer (hereinafter, referred to as a host PC) 306 via an interface 307. Various data, a control signal related to the printing, or the like transmitted from the host PC 306 is inputted to a printing control unit 301 of the printing apparatus 101. The printing control unit 301 includes a memory 303 that stores input image data, multivalued gradation data of an intermediate product, and a multipath mask and a CPU 302 (that may be an ASIC) that is a control computation apparatus. Additionally, the printing control unit 301 includes an image processing unit 304 that performs various types of image processing and a data processing unit 305 that performs various types of data processing. The processing of the image processing unit 304 and the data processing unit 305 may be executed by the CPU 302. The printing control unit 301 controls a motor driver and a head driver described later according to the control signal inputted via the interface 307.

The conveyance motor 204 is a motor that rotates and drives the conveyance roller to convey the printing medium 103. The carriage motor 205 is a motor that reciprocally drives the carriage unit 102 on which the printing head 110 is mounted. A recovery unit motor 206 is a motor mounted on the recovery unit 210 and switches a unit to be driven by a camshaft to operate a wiper guide 223 and the suction pump 213 (FIG. 4). Motor drivers 308, 309, and 310 are drivers that rotate and drive the conveyance motor 204, the carriage motor 205, and the recovery unit motor 206, respectively. A head driver 311 is a driver that drives the printing head 110, and in a case where multiple printing heads are mounted, multiple head drivers 311 corresponding to the number of the printing heads are provided.

### Printing Head Configuration

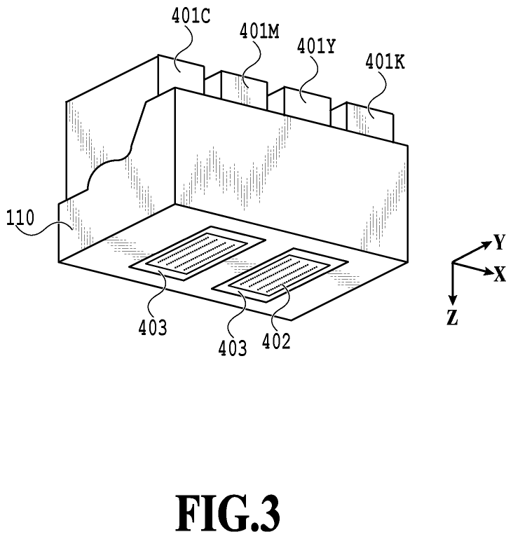

FIG. 3 is a diagram describing a configuration of the printing head 110 in the present embodiment. FIG. 3 is a diagram illustrating an example of the printing head 110 and an ejection port group configuration. The printing head 110 in the present embodiment includes independent buffer tanks 401C, 401M, 401Y, and 401BK corresponding to four colors of inks of cyan, magenta, yellow, and black. Note that, although FIG. 3 illustrates the buffer tanks visible for the sake of description, the buffer tank is actually stored inside the printing head 110. On a lower surface (+Z direction) of the printing head 110, a chip 403 on which an ejection port array corresponding to each ink is formed is arranged. On the chip 403, 1024 ejection ports 402 are formed to be arrayed in two arrays at an interval of 1200 dpi for each color, and thus each chip can eject two colors. It is possible to perform printing in four colors by arranging two chips 403 as described above. Note that, the ejection port arrays of one color are not necessarily arranged in the same straight line and may be in a staggered arrangement, and 512 ejection ports may be arranged in four arrays in total at an interval of 600 dpi. Note that, although FIG. 3 describes a configuration including the independent buffer tanks for the four colors of inks as an example, the colors may be all the same, and it is possible to adopt an arbitrary mode for the number of colors and arrangement of the ink.

### Recovery Unit

FIG. 4 is a schematic view of the recovery unit 210 according to the present embodiment. The recovery unit 210 includes the cap 211 that covers the ejection port surface of the printing head 110 and the suction pump 213 that sucks the ink from the printing head 110 in a state where the cap 211 covers the ejection port surface. Additionally, the recovery unit 210 includes a first wiper 221 and a second wiper 222 that wipe the ejection port surface of the printing head 110. The recovery unit 210 is arranged outside a printing region in a movement direction (the X direction) of the carriage unit 102. The carriage unit 102 stops at a waiting position outside the printing region as needed before starting the printing operation and during the printing operation. The recovery unit 210 is arranged in a position facing the printing head 110 in a case where the carriage unit 102 is stopped at the waiting position.

The cap 211 is supported to be able to be raised and lowered by a not-illustrated raising and lowering mechanism and is moved between a raised position and a lowered position. In the raised position, the cap 211 is put in contact with the printing head 110 and covers (caps) the ejection port surface of the printing head 110. The cap 211 can suppress drying of the ejection ports 402 of the printing head and evaporation of the ink during a non-printing operation by covering the ejection port surface of the printing head 110. Additionally, the cap 211 can suck the ink from the printing head 110 by driving the later-described suction pump 213. Moreover, during the printing operation, the cap 211 is positioned in the lowered position to avoid interference with the printing head 110 moved with the carriage unit 102. In a state in which the cap 211 is positioned in the lowered position, the printing head 110 can perform preliminary ejection on the cap 211 in a case where the printing head 110 is moved to a position facing the cap 211. The preliminary ejection is ejection of the ink that is not used for the printing on the printing medium 103 and is an operation to discharge a color-mixed ink, a foreign substance, a thickened ink, and the like that invade the inside of the printing head (the inside of the liquid ejection head) to the outside of the printing head.

The first wiper (wiper blade) 221 and the second wiper (wiper blade) 222 are formed of an elastic member such as rubber. In the present embodiment, two first wipers 221 that wipe the ejection port surfaces of the two chips 403 in FIG. 3, respectively, and the second wiper 222 that wipes the entire ejection port surface including the ejection port arrays are provided. The first wiper 221 and the second wiper 222 are fixed to a wiper holder 220. The wiper holder 220 can be moved in a front and rear direction in the diagram that is indicated by an arrow W (an array direction of the ejection ports in the printing head, that is, the Y direction) along the wiper guide 223. With the wiper holder 220 being moved in the arrow W direction (one direction) in a case where the printing head 110 is positioned at the waiting position, it is possible to perform a wiping operation in which the first wiper 221 and the second wiper 222 wipe the ejection port surface while being put in contact with the ejection port surface. Once the wiping operation ends, the carriage unit 102 is moved and retracted from the region in which the wiping operation is performed, and then wiper holder 220 is moved to return the first wiper 221 and the second wiper 222 to the original position (a position before the wiping operation).

Note that, although the present embodiment is described using an example including the first wiper 221 and the second wiper 222, a configuration including only either one of the wipers may be applied. Additionally, although the present embodiment is described using an example in which the wiper is formed of an elastic member such as rubber, a member formed of a porous material that sucks the ink may be applied. Moreover, the wiper may have a configuration of a vacuum wiper that can suck the ejection port surface. Furthermore, although the present embodiment is described using an example in which the wiping is performed only in a case where the wiper is moved in one direction, a configuration in which the wiping is performed in a case where the wiper is moved in two directions reciprocally may be applied. Additionally, although the present embodiment is described using an example in which the wiping direction is the array direction (the Y direction) of the ejection ports in the printing head, a configuration in which the wiper is moved in a direction (an arrangement direction of the ejection port arrays, the X direction) crossing (orthogonal to) the above-mentioned direction may be applied. Moreover, in the configuration, a configuration in which the wiper is fixed, and the ejection port surface is wiped with the carriage unit 102 being moved in the scanning direction may be applied. Furthermore, a configuration in which the wiper is moved in both the X direction and Y direction for the wiping may be applied. Additionally, in a configuration in which the wiping is performed with multiple wiping members or performed in different wiping directions, positions of the corresponding recovery units may be arranged separately. In this case, the recovery unit 210 may be arranged to be divided into a portion near the waiting position of the carriage unit 102 and a portion on the opposite side of the printing medium to the waiting position.

In a case where the ejection port surface is wiped by the wiper, there is a possibility that the color-mixed ink and the like invade the ejection port on a side downstream of the wiping. To deal with this, in the present embodiment, a preliminary ejection operation is performed after the recovery operation by the wiping is performed.

The suction pump 213 is driven in a state in which the cap 211 covers the ejection port surface of the printing head 110 to form a substantially sealed space therein. With this, a negative pressure is generated inside the cap 211, and thus the suction operation to suck the ink from the printing head 110 is performed. This suction operation is performed in a case of filling the printing head 110 with the ink from the ink tank 202 (in initial filling) or a case of sucking and removing dust, a sticking matter, air bubbles, or the like inside the ejection port (in suction recovery), for example. The cap 211 is connected with a not-illustrated waste ink absorbent member via a flexible tube 212.

In the present embodiment, a tube pump is used as the suction pump 213. The tube pump includes a holding unit in which a curved surface portion is formed to keep along therewith and hold at least a part of the tube 212, a roller that can press the held tube 212, and a roller support unit that supports the roller rotatably. The tube pump rotates the roller while pressing the tube 212 by rotating the roller support unit in a predetermined direction. With this, a negative pressure is generated inside the cap 211, and the ink is sucked from the printing head 110. The sucked ink is discharged to the waste ink absorbent member via the tube 212. Additionally, the suction operation is performed also in a case where the printing head 110 performs the preliminary ejection on the cap 211, and the ink that is received in the cap 211 by the preliminary ejection is discharged to the outside of the cap 211. That is, it is possible to discharge the ink held in the cap 211 to the waste ink absorbent member via the tube 212 by driving the suction pump 213 once the ink held in the cap 211 by the preliminary ejection reaches a predetermined amount.

Thus, the recovery unit 210 performs the recovery operation to recover the ejection port surface to a normal state. The recovery operation may be called a cleaning operation or a cleanup operation. Additionally, the recovery unit 210 may be called a maintenance unit that performs maintenance of the ejection port surface.

### Ink Circulation

FIG. 5 is a diagram schematically illustrating a configuration of the printing head 110. In this case, it is a schematic view of a channel of one color. In the present embodiment, as described above, the buffer tanks and the channels of four colors, which are cyan, magenta, yellow, and black, are included in the single printing head 110. The supply tube 105 connected to the ink tank 202 is connected to a joint 404 of a head main body 120 through the inside of the carriage unit 102 and communicates with the buffer tank 401. The supplied ink passes through a filter 405 and reaches a first pressure control chamber 406 by way of the channel in the buffer tank 401. The first pressure control chamber 406 is connected with a second pressure control chamber 407, which is the other pressure control chamber, via the channel and is connected with the second pressure control chamber 407 also via another channel that is through a circulation driving pump 408.

A valve 411 that opens once reaching a predetermined negative pressure is provided to an inlet port of the first pressure control chamber 406. A valve 412 that opens once reaching a predetermined negative pressure is provided to an inlet port of the second pressure control chamber 407. The inlet port of the first pressure control chamber 406 is provided to the channel between the first pressure control chamber 406 and the filter 405. The inlet port of the second pressure control chamber 407 is provided to the channel between the second pressure control chamber 407 and the first pressure control chamber 406. In the configuration, the negative pressure that opens the valve 412 of the inlet port of the second pressure control chamber 407 is higher than the negative pressure that opens the valve 411 of the first pressure control chamber 406.

The ink is supplied to the inside of the chip 403 from the first pressure control chamber 406 via a common supply channel 409 formed in the head main body 120. To be specific, the ink is supplied to a supply channel (described later) of one or more ejection port arrays arranged in the chip 403 from the common supply channel 409. Then, the ink is ejected from each ejection port 402. Additionally, the ink that is not ejected is collected into the buffer tank 401 by way of the ejection port 402. That is, the ink that passes through the ejection port 402 passes through a common collection channel 410 formed in the head main body 120 from the collection channel (described later) in the chip 403 and is collected into the second pressure control chamber 407.

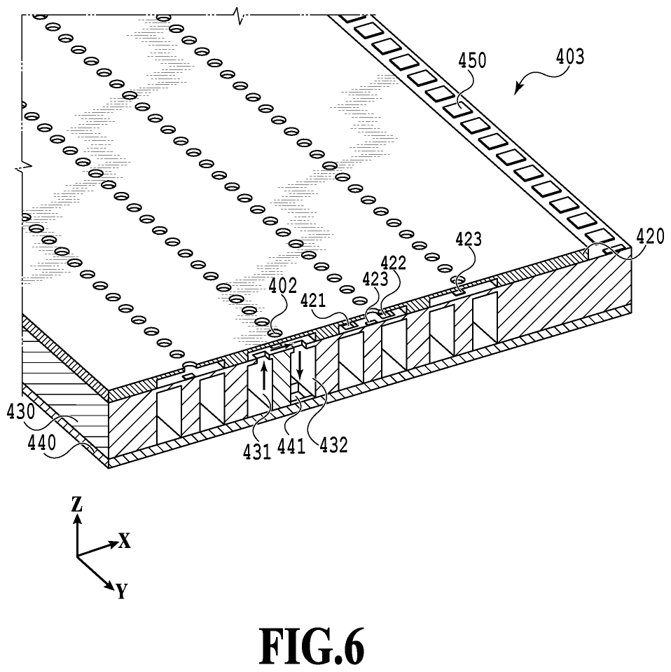

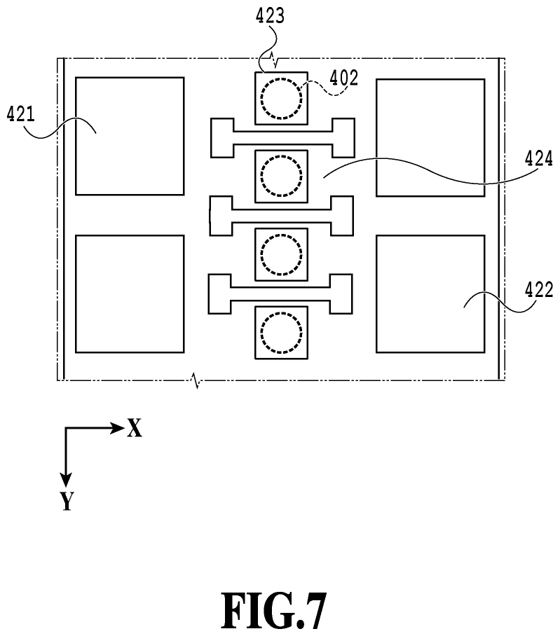

FIG. 6 is a diagram illustrating a configuration of the ejection port 402 and the channel formed in the chip 403 and a flow of the ink. FIG. 7 is a schematic view of a bottom surface (a surface on which the ejection ports 402 are arrayed) of the chip 403. Hereinafter, the configuration of the ejection port 402 and the channel formed in the chip 403 and the flow of the ink are described with reference to FIGS. 6 and 7. The ejection port 402 is formed in an orifice plate 420 of a surface of the chip 403. An energy generation element 423 that generates ejection energy to eject the ink is included in a position (a pressure chamber 424) corresponding to the ejection port 402 on a board 430. That is, the energy generation element 423 is provided in correspondence with each ejection port 402. As the energy generation element 423, an electrothermal element (a heater), a piezoelectric element, or the like may be used. In a case where the heater is used, bubbles are generated in the ink in the ejection port 402 by heating, and it is possible to eject the ink from the ejection port 402 by using bubble generation energy therefrom.

In a state in which the ink is supplied, the chip 403 is maintained at a negative pressure that forms a meniscus on the ejection port surface. Two channels of an inlet port 421 and an outlet port 422 are formed on two sides of the ejection port 402, respectively. In the present embodiment, as illustrated in FIG. 7, the inlet port 421 and the outlet port 422 are each arranged in correspondence with the two ejection ports 402. Note that, as for the number of the inlet port 421 and the outlet port 422, one inlet port 421 and one outlet port 422 may be arranged for each ejection port 402. One inlet port 421 and one outlet port 422 may be arranged for two or more ejection ports 402. Additionally, the numbers of the inlet port 421 and the outlet port 422 may not be the same. As illustrated in FIG. 6, the inlet port 421 and the outlet port 422 are connected to a supply channel 431 and a collection channel 432 each formed along an ejection port array direction (the Y direction), respectively. The supply channel 431 and the collection channel 432 are covered with a cover plate 440 and are connected to the common supply channel 409 and the common collection channel 410 of the head main body 120 via an opening portion 441 in the cover plate. One or more opening portions 441 are provided for each of the supply channel 431 and the collection channel 432. Note that, the number of the opening portion 441 may either be the same or different between the supply channel and the collection channel. The common supply channel 409 or the supply channel 431 is referred to as a first channel, and the common collection channel 410 or the collection channel 432 is referred to as a second channel.

Next, with reference to FIG. 5, a method of supplying the ink to the printing head 110 and the buffer tank 401 and a method of circulating the ink in the ejection port in the present embodiment are described. The ink is pressurized from the ink tank 202 to reach the inside of the printing head 110 via the supply tube 105, passes through the filter 405, and flows into the channel before the valve 411 arranged in the inlet port of the first pressure control chamber 406. In a state in which the printing head is filled with the ink at a proper negative pressure to hold the meniscus on the ejection port surface, the valve 411 arranged in the inlet port of the first pressure control chamber 406 is in a closed state, and the ink does not flow into the first pressure control chamber 406. On the other hand, in a case where a strong negative pressure is applied to the ejection port 402 by the suction operation of the recovery unit 210 using the cap 211 or in a case where the ink is ejected from the ejection port 402, for example, once the negative pressure in the first pressure control chamber 406 is increased, the valve 411 in the inlet port is opened. Then, the ink flows into the first pressure control chamber 406.

As illustrated in FIG. 5, the first pressure control chamber 406 and the second pressure control chamber 407 are connected to the circulation driving pump 408. In a case where the circulation driving pump 408 is driven, the ink is transferred from the second pressure control chamber 407 to the first pressure control chamber 406 via the circulation driving pump 408. With this, the negative pressure in the second pressure control chamber 407 is increased, and the valve 412 in the inlet port of the second pressure control chamber 407 is opened; thus, the ink flows back from the first pressure control chamber 406 to the second pressure control chamber 407. Additionally, in this process, since a pressure difference occurs between the first pressure control chamber 406 and the second pressure control chamber 407, a flow of the ink passing through the ejection port 402 occurs. That is, the ink passes through the channels in the order from the first pressure control chamber 406, the common supply channel 409, the opening portion 441 of the cover plate 440, the supply channel 431 of each ejection port array, and the inlet port 421, and a part of the ink flows into the ejection port 402. Additionally, the ink passes through the channels in the order from the ejection port 402, the outlet port 422, the collection channel 432, the opening portion 441 of the cover plate 440, and the common collection channel 410, and the ink is collected into the second pressure control chamber 407. That is, the flow of the ink in the chip 403 flows in a direction of an arrow illustrated in FIGS. 5 and 6. Note that, the negative pressure and an ink flow velocity in the ejection port 402 are adjusted to be within a range that can hold the meniscus. That is, the negative pressure and the ink flow velocity in the ejection port 402 are adjusted by adjusting a flow rate in the circulation driving pump 408, a pressure loss in the channel between the first pressure control chamber 406 and the second pressure control chamber 407, and opening and closing force of the valve in the inlet port.

As above, with the circulation driving pump 408 being driven, the flow to move the ink near the ejection port 402 is generated, and it is possible to suppress the rise in the ink viscosity due to dryness in the ejection port during the printing operation and to suppress the impairment of the ejection characteristic of the ink.

### Composition of Ink

Next, the ink used in the present embodiment is described. Hereinafter, “percent” and “%” are mass standard unless otherwise stated.

### (Black Ink)

### (1) Production of Pigment Dispersion Liquid

First, an anionic polymer P-1 [styrene/butyl acrylate/acrylic acid copolymer (polymerization ratio (ratio by weight)=30/40/30) acid value of 202, weight average molecular weight of 6500] was prepared. This was neutralized with potassium hydroxide aqueous solution and diluted with ion-exchanged water to produce homogeneous 10% by mass polymer aqueous solution.

Then, 100 g of the above-described polymer solution, 100 g of carbon black, and 300 g of ion-exchanged water were mixed and mechanically agitated for 0.5 hours. Next, a microfluidizer was used to process this mixture by passing through an interaction chamber five times under a liquid pressure of about 70 MPa. In addition, centrifugation processing (12,000 rpm, 20 minutes) was performed on the dispersion liquid obtained as described above to remove a non-dispersive substance including a coarse particle, and a black dispersion liquid was obtained. In the obtained black dispersion liquid, the pigment concentration was 10% by mass, and the dispersant concentration was 6% by mass.

### (2) Production of Resin Fine Particle Dispersion Liquid

First, under a nitrogen atmosphere, in a state heated at 70° C., the later-described three types of additive liquids were added by dripping little by little while agitating by the motor, and polymerization was performed five times. Each additive liquid was hydrophobic monomer formed of methacrylic methyl of 28.5 percent, a mixed liquid including hydrophilic monomer formed of p-styrene sodium sulfonate of 4.3 percent and water of 30 percent, and a mixed liquid including a polymerization initiator formed of potassium persulfate of 0.05 percent and water of 30 percent.

### (3) Production of Ink

The production of the ink used the above-described black dispersion liquid and the above-described resin fine particle dispersion liquid. The following components were added to the liquids to obtain a predetermined concentration, and after these components were mixed and agitated sufficiently, pressurization and filtration were performed by a microfilter (manufactured by FUJIFILM Corporation) of pore size of 2.5 um, and a pigment ink of a pigment concentration of 5% by mass and a dispersant concentration of 3% by mass was prepared.
Above-described black dispersion liquid 50 percent
Above-described resin fine particle dispersion liquid 10 percent
2-methyl 1,3 propanediol 15 percent
2-pyrrolidone 5 percent
Acetylene glycol EO adduct 0.5 percent
Ion-exchanged water (manufactured by Kawaken Fine Chemicals Co., Ltd.) all the rest.

### (Cyan Ink)

### (1) Production of Dispersion Liquid

First, an AB diblock polymer of an acid value of 250 and a number average molecular weight of 3000 was produced by a routine method using benzyl acrylate and methacrylic acid as raw materials, and in addition, the product was neutralized with potassium hydroxide aqueous solution and diluted with ion-exchanged water; thus, homogeneous 50% by mass polymer aqueous solution was produced.

Then, 180 g of the above-described polymer solution, 100 g of C.I. pigment blue 15:3, and 220 g of ion-exchanged water were mixed and mechanically agitated for 0.5 hours.

Next, the microfluidizer was used to process this mixture by passing through the interaction chamber five times under a liquid pressure of about 70 MPa.

In addition, centrifugation processing (12,000 rpm, 20 minutes) was performed on the dispersion liquid obtained as described above to remove a non-dispersive substance including a coarse particle, and a cyan dispersion liquid was obtained. In the obtained cyan dispersion liquid, the pigment concentration was 10% by mass, and the dispersant concentration was 10% by mass.

### (2) Production of Resin Fine Particle Dispersion Liquid

The resin fine particle dispersion liquid was produced by the raw materials and the production method similar to that described for the above-described black ink.

### (3) Production of Ink

The production of the ink used the above-described cyan dispersion liquid, and the following components were added to the liquid to obtain a predetermined concentration. Then, after these components were mixed and agitated sufficiently, pressurization and filtration were performed by the microfilter (manufactured by FUJIFILM Corporation) of pore size of 2.5 μm, and a pigment ink of a pigment concentration of 2% by mass and a dispersant concentration of 2% by mass was prepared.
Above-described cyan dispersion liquid 20 percent
Above-described resin fine particle dispersion liquid 10 percent
2-methyl 1,3 propanediol 15 percent
2-pyrrolidone 5 percent
Acetylene glycol EO adduct 0.5 percent
Ion-exchanged water (manufactured by Kawaken Fine Chemicals Co., Ltd.) all the rest.

### (Magenta Ink)

### (1) Production of Dispersion Liquid

First, an AB diblock polymer of an acid value of 300 and a number average molecular weight of 2500 was produced by a routine method using benzyl acrylate and methacrylic acid as raw materials, and in addition, the product was neutralized with potassium hydroxide aqueous solution and diluted with ion-exchanged water; thus, homogeneous 50% by mass polymer aqueous solution was produced.

Then, 100 g of the above-described polymer solution, 100 g of C.I. pigment red 122, and 300 g of ion-exchanged water were mixed and mechanically agitated for 0.5 hours.

Next, the microfluidizer was used to process this mixture by passing through the interaction chamber five times under a liquid pressure of about 70 MPa.

In addition, centrifugation processing (12,000 rpm, 20 minutes) was performed on the dispersion liquid obtained as described above to remove a non-dispersive substance including a coarse particle, and a magenta dispersion liquid was obtained. In the obtained magenta dispersion liquid, the pigment concentration was 10% by mass, and the dispersant concentration was 5% by mass.

### (2) Production of Resin Fine Particle Dispersion Liquid

The resin fine particle dispersion liquid was produced by the raw materials and the production method similar to that described for the above-described black ink.

### (3) Production of Ink

The production of the ink used the above-described magenta dispersion liquid, and the following components were added to the liquid to obtain a predetermined concentration. Then, after these components were mixed and agitated sufficiently, pressurization and filtration were performed by the microfilter (manufactured by FUJIFILM Corporation) of pore size of 2.5 μm, and a pigment ink of a pigment concentration of 4% by mass and a dispersant concentration of 2% by mass was prepared.
Above-described magenta dispersion liquid 40 percent
Above-described resin fine particle dispersion liquid 10 percent
2-methyl 1,3 propanediol 15 percent
2-pyrrolidone 5 percent
Acetylene glycol EO adduct 0.5 percent
Ion-exchanged water (manufactured by Kawaken Fine Chemicals Co., Ltd.) all the rest.

### (Yellow Ink)

### (1) Production of Dispersion Liquid

First, the above-described anionic polymer P-1 was neutralized with potassium hydroxide aqueous solution and diluted with ion-exchanged water to produce homogeneous 10% by mass polymer aqueous solution.

The above-described polymer solution of 30 percent, C.I. pigment yellow 74 of 10 percent, and ion-exchanged water of 60 percent were mixed, the mixture was set to a batch-type vertical sand mill (manufactured by IMEX Co., Ltd.), zirconia beads of a diameter of 0.3 mm of 150 percent was filled, and dispersion processing was performed for 12 hours with water cooling.

In addition, centrifugation processing was performed on the dispersion liquid obtained as described above to remove a non-dispersive substance including a coarse particle, and a yellow dispersion liquid was obtained. In the obtained yellow dispersion liquid, the solid content was about 12.5%, and the weight average particle diameter was 120 nm.

### (2) Production of Resin Fine Particle Dispersion Liquid

The resin fine particle dispersion liquid was produced by the raw materials and the production method similar to that described for the above-described black ink.

### (3) Production of Ink

The following components were mixed, sufficiently agitated, and dissolved and dispersed. Thereafter, pressurization and filtration were performed by a microfilter (manufactured by FUJIFILM Corporation) of pore size of 1.0 μm to prepare the ink.
Above-described yellow dispersion liquid 40 percent
Above-described resin fine particle dispersion liquid 10 percent
2-methyl 1,3 propanediol 15 percent
2-pyrrolidone 5 percent
Acetylene glycol EO adduct 0.5 percent
Ion-exchanged water (manufactured by Kawaken Fine Chemicals Co., Ltd.) all the rest.

A characteristic of the ink used in the present embodiment is that the ink contains a “resin fine particle” to fix the ink on a non-penetrant printing medium. The “resin fine particle” means a fine particle formed of resin and having a particle diameter that allows for dispersion into an aqueous medium. The resin fine particle has a function to fix the pigment on a surface of the printing medium by being melted by heating and forming a film (film-forming) on the surface of the printing medium.

In the present disclosure, it is preferable that a glass transition point Tg of the resin forming the resin fine particle is higher than 30° C. and lower than 80° C. In a case of 30° C. or lower, a difference between Tg of the resin and a room temperature is small, and it is a state in which the resin fine particle in the ink is close to a melting state; for this reason, in some cases, the viscosity of the ink rises in the head, and the grade (such as color developability and sharpness) of the image is reduced due to defective ejection of the ink. In a case of 80° C. or higher, more heat is required in a heating and drying unit to melt the resin fine particle, and in some cases, it is impossible to melt the resin fine particle before the aggregation of the pigments along with evaporation of water in the ink occurs, and the grade (such as color developability) of the image is reduced.

The resin forming the resin fine particle is not particularly limited as long as the glass transition point Tg satisfies the above-described range. Specifically, acrylic resin, styrene-acrylic resin, polyethylene resin, polypropylene resin, polyurethane resin, styrene-butadiene resin, fluoroolefin-based resin, and the like may be included. For example, it is possible to synthesize the acrylic resin by emulsion polymerization of monomer of (meta) alkyl acrylate ester, (meta) alkyl acrylamide, and the like. Additionally, it is possible to synthesize the styrene-acrylic resin by emulsion polymerization of (meta) alkyl acrylate ester, (meta) alkyl acrylamide, and the like with styrene monomer. With the emulsion polymerization, it is possible to obtain emulsion in which the fine particle (the resin fine particle) formed of the above-described resin is dispersed in the medium.

In the present disclosure, as the resin fine particle including a sulfonic acid group, it is possible to use the resin fine particle that is insoluble in water and formed of any resin component used commonly. The resin component forming the resin fine particle is not particularly limited as long as it is resin including the sulfonic acid group, and it is possible to use any resin components such as any natural or synthetic polymers used commonly, newly developed polymers for the present disclosure, or the like, with no limitation. Particularly, in terms of common use and simple function designing of the resin fine particle, it is possible to use a polymer or a copolymer of a monomer component having radical polymerizable unsaturated bond, such as acrylic resin and styrene/acrylic resin.

In general, a surfactant is used as a penetrant for purpose of improving the permeability of the ink into the printing medium dedicated for ink jet. In a case of the non-penetrant printing medium, the surfactant is used for purpose of improving the wettability. The greater the amount of the surfactant added, the stronger the property of reducing the surface tension of the ink, and the more improved the wettability and the permeability of the ink on the printing medium. It is preferable to use surfactant acetylene glycol EO adduct or a fluorine or silicone surfactant. Since the fluorine or silicone surfactant can reduce the surface tension of the ink with a small amount of the containing amount, it is possible to enhance the wettability of the ink on the printing medium. With this, even in a case where printing is performed on a non-absorbent printing medium, a phenomenon in which the ink is repelled on the surface of the printing medium is suppressed, and it is possible to further improve the image quality. In a case of the present embodiment, all the inks were set to have the surface tension of 30 dyn/cm or smaller as preferable surface tension. The surface tension was measured by using a fully automatic surface tensiometer CBVP-Z (manufactured by Kyowa Interface Science Co., Ltd.). Note that, as long as it is possible to measure the surface tension of the ink, the measurement equipment is not limited to the above-described example.

Additionally, since anionic color material is used for all the inks in the present embodiment, pH of the ink is stable on alkali side, and a value thereof is 8.5 to 9.5. In terms of preventing dissolution of impurities from a member that is put in contact with the ink, deterioration of a material forming the member, reduction in the solubility of pigment dispersion resin in the ink, and the like, in general, pH of the ink is preferably 7.0 or greater and 10.0 or smaller. The measurement of pH was performed by using pH METER F-52 manufactured by HORIBA, Ltd. Note that, as long as it is possible to measure pH of the ink, the measurement equipment is not limited to the above-described example.

### Execution Timings of Recovery Operation and Preliminary Ejection

In the printing apparatus 101 having the configuration as described above, the ink in a channel (in the pressure chamber) passing through the nozzle operation is circulated during the printing. In addition, in the present embodiment, a determination method and control of execution timings of the recovery operation of a nozzle surface (the ejection port surface) and the preliminary ejection after the printing operation ends are described. With this, it is possible to suppress the thickened ink, the foreign substance, and the color-mixed ink, which invade the inside of the nozzle in a case where the recovery operation is executed, from flowing deep into the circulation channel, and it is possible to reduce an effect on the image and the ink ejection performance. Additionally, it is possible to shorten the time until the recovery operation starts, and it is possible to suppress the productivity reduction.

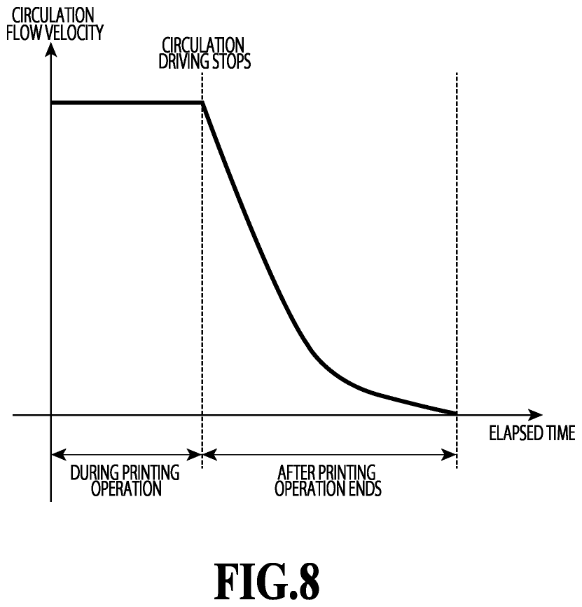

FIG. 8 is a graph illustrating an ink flow velocity in an in-nozzle circulation channel with respect to an elapsed time in a case from during the printing operation to when the circulation is stopped after the printing operation ends. The in-nozzle circulation channel is a channel passing through the pressure chamber 424. As described above, the circulation driving pump 408 is driven to stabilize the ejection characteristic by circulating the ink in the nozzle during the printing operation. Note that, for the sake of simplifying the description, it is assumed that there is no ink ejection from the nozzle during the printing operation illustrated in FIG. 8, and it is assumed that a constant pressure difference occurs and thus the flow velocity of the ink is also constant between the first pressure control chamber 406 and the second pressure control chamber 407. Note that, in a case where the ink is ejected, the negative pressure in the first pressure control chamber 406 and the second pressure control chamber 407 is increased temporarily, and the pressure difference is also changed. However, as described above, the pressure state returns to the original pressure state with the valve 411 in the inlet port of the first pressure control chamber 406 being opened, and the ink being supplied from the ink tank 202 to the buffer tank 401. Therefore, although the flow velocity may be changed locally according to the ejection of the ink, for the simple description, it is described in FIG. 8 that there is no ink ejection. Once the printing operation ends, the printing head 110 returns to the waiting position by control by the printing control unit 301, and after the recovery unit 210 executes the necessary recovery operation, capping is performed.

Once the printing head 110 returns to the waiting position, the printing control unit 301 moves the wiper of the recovery unit 210 (the first wiper 221 and the second wiper 222) to a wiping start position. After the printing operation ends, it is unnecessary to suppress the viscosity rise due to the evaporation by circulating the ink in the nozzle; for this reason, the printing control unit 301 stops the driving of the circulation driving pump 408 in a timing when the circulation driving stops that is illustrated in FIG. 8. However, immediately after the circulation flow velocity of the ink by the pump driving ceases, the pressure difference remains between the first pressure control chamber 406 and the second pressure control chamber 407. In addition, since the valve 412 in the inlet port of the second pressure control chamber 407 is opened, the ink keeps flowing continuously for a certain time in the channel between the pressure control chambers and the channel passing through the nozzle. The pressure difference between the first pressure control chamber 406 and the second pressure control chamber 407 is equalized gradually with the ink flowing; therefore, the valve 412 is closed, the ink flows by way of the nozzle additionally, and the flow velocity of the ink becomes slow accordingly. Then, after a certain time elapses, the ink almost stops flowing.

In a case where the time from when the circulation driving stops to when the wiping starts is longer than the time from the when above-described circulation driving stops to when the circulation flow velocity stops, the wiping is performed in a state in which the circulation flow velocity stops. Therefore, even in a case where the wiping starts, the problem of the invasion of the circulation channel deep by the thickened ink, the foreign substance, and the color-mixed ink in a nozzle surface layer does not occur.

However, in a case where the wiping starts after waiting until the time when the circulation flow velocity stops, the wiping operation starts late due to the waiting time, and accordingly the printing operation of the next printing image starts late as well. Accordingly, the productivity of the printing apparatus 101 is reduced.

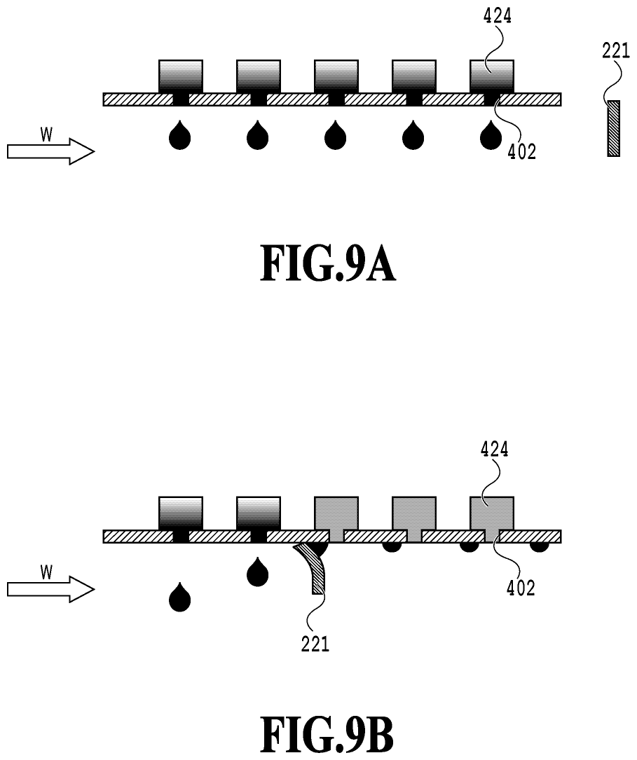

FIGS. 9A and 9B are diagrams schematically illustrating the wiping and the preliminary ejection operation. FIG. 9A illustrates a comparative example in a case where the wiping is executed and the preliminary ejection is performed without waiting until the circulation flow velocity stops. FIGS. 9A and 9B illustrate the first wiper 221 as an example of the wiper. FIG. 9A illustrates an example in which the preliminary ejection is performed after the first wiper 221 completes wiping the nozzle surface of the printing head 110 in a direction W. In a case where the wiping is executed without waiting until the circulation flow velocity stops, as illustrated in FIG. 9A, the thickened ink, the foreign substance, and the color-mixed ink are caused to flow deep into the circulation channel (for example, the outlet port 422) by the circulation. That is, the thickened ink and the like invading deep into the nozzle (in the ejection port 402 and in the pressure chamber 424) by the wiping operation are caused to flow deep into the circulation channel (for example, the outlet port 422) by the circulation. Therefore, there is a possibility that the thickened ink, the foreign substance, and the color-mixed ink cannot be removed even if the preliminary ejection is performed after the wiping operation is completed.

FIG. 9B illustrates an operation example of the wiping and the preliminary ejection in the present embodiment. As illustrated in FIG. 9B, in the present embodiment, the preliminary ejection is executed from the nozzle in which the wiping operation is completed. That is, before the first wiper 221 completes wiping of all the ejection ports 402 (nozzles), the preliminary ejection is executed from the nozzle in which the wiping operation is completed. In other words, the preliminary ejection is controlled to be executed in different timings for each nozzle. With the preliminary ejection being executed from the nozzle in which the wiping operation is completed, that is, with the wiping operation and the preliminary ejection being executed in parallel, it is possible to suppress the thickened ink, the foreign substance, and the color-mixed ink invading the inside of the nozzle from flowing deep into the circulation path. As a result, it is possible to reduce an effect on the image and the ink ejection performance.

However, in a case where the wiping is executed without waiting until the circulation flow velocity stops after the circulation driving stops, it is a state in which the circulation flow velocity is lower than that during the printing operation of the image on the printing medium 103. Therefore, in a case where the preliminary ejection is executed in a timing when the circulation flow velocity becomes lower than the circulation flow velocity at which the ink can be ejected, the ejection cannot be performed, and there is a possibility that the thickened ink, the foreign substance, and the color-mixed ink cannot be eliminated. Once the circulation flow velocity becomes lower than the circulation flow velocity at which the ink can be ejected even if only slightly, there may be a nozzle with defective ejection due to an effect of thickening and the like. Therefore, it is possible to say that the circulation flow velocity at which the ink can be ejected is a circulation flow velocity to the extent that the ejection port is not clogged with the thickened ink.

In the present embodiment, the following method is executed to avoid a failure in the ejection in a case where the preliminary ejection is executed in a timing when the circulation flow velocity becomes lower than the circulation flow velocity at which the ink can be ejected as described above.

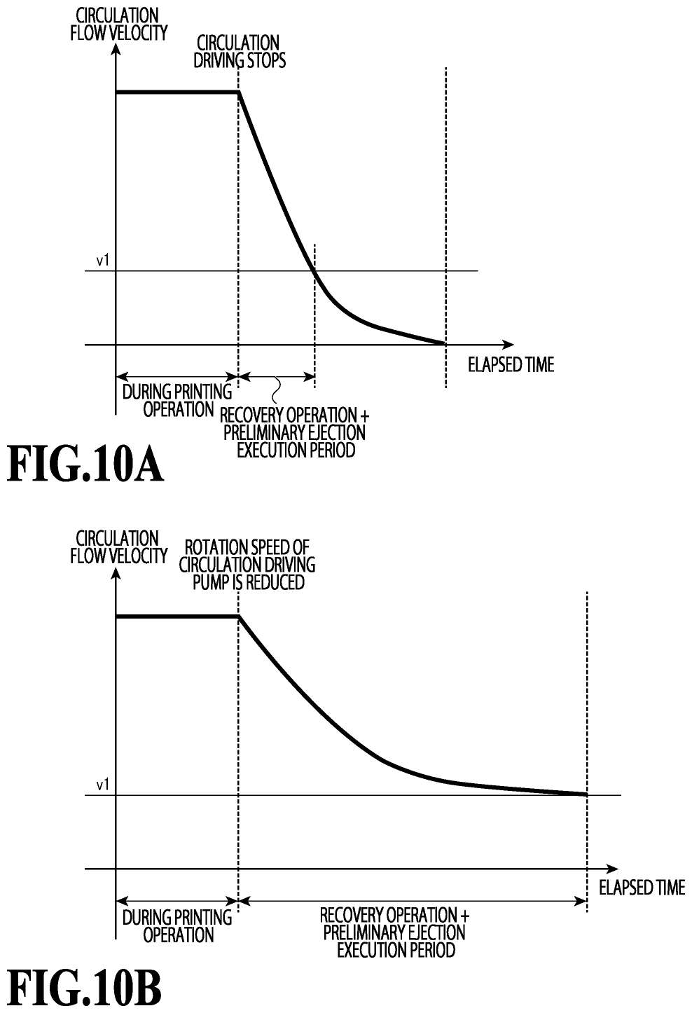

FIGS. 10A and 10B are diagrams illustrating a recovery operation (wiping operation) and preliminary ejection execution period in the present embodiment. As illustrated in FIG. 10A, the wiping and the preliminary ejection operation are completed within a time range in which the circulation flow velocity of the printing head 110 is equal to or greater than a circulation flow velocity v1 at which the ink can be ejected. With this, it is possible to execute the preliminary ejection properly, and thus it is possible to suppress the thickened ink, the foreign substance, and the color-mixed ink invading the inside of the nozzle from flowing deep into the circulation path. Therefore, it is possible to reduce an effect on the image and the ink ejection performance.

Note that, although a case where the circulation driving is stopped after the printing operation of the image on the printing medium 103 is completed is described as an example in the present embodiment, it is not limited to this example. For example, there may be a case where the wiping and the preliminary ejection operation cannot be completed within the time range in which the circulation flow velocity of the printing head 110 is equal to or greater than the circulation flow velocity v1 at which the ink can be ejected from when the circulation driving stops. In such a case, for example, as illustrated in FIG. 10B, a rotation speed of the circulation driving pump 408 is reduced. It is possible to increase the time range in which the circulation flow velocity of the printing head 110 is equal to or greater than the circulation flow velocity v1 at which the ink can be ejected by reducing the rotation speed of the circulation driving pump 408. Therefore, it is possible to complete the wiping and the preliminary ejection operation within the time range in which the circulation flow velocity of the printing head 110 is equal to or greater than the circulation flow velocity at which the ink can be ejected from when the circulation driving stops.

Note that, a method of dealing with a case where the wiping and the preliminary ejection operation cannot be completed within the time range in which the circulation flow velocity of the printing head 110 is equal to or greater than the circulation flow velocity v1 at which the ink can be ejected from when the circulation driving stops is not limited to the example in which the rotation speed of the circulation driving pump 408 is reduced.

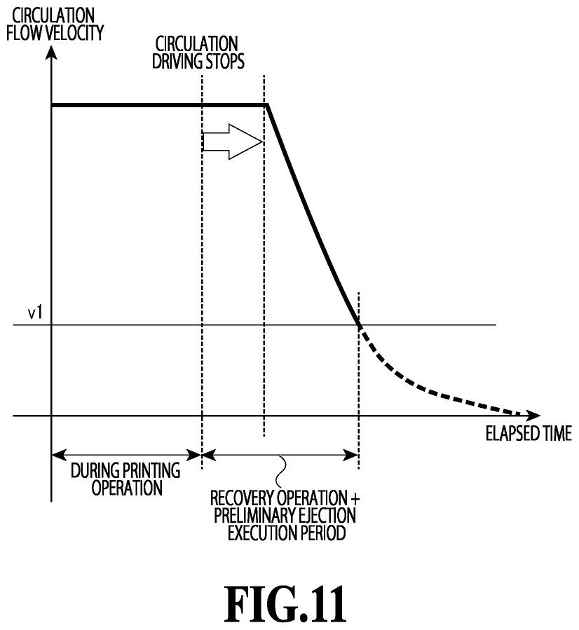

FIG. 11 is a diagram illustrating another example of the recovery operation and preliminary ejection execution period in the present embodiment. As illustrated in FIG. 11, after the printing operation of the image on the printing medium 103 is completed, the wiping operation and the preliminary ejection operation are executed without stopping the circulation driving. With the circulation driving being stopped after the wiping is started, it is possible to control the wiping and the preliminary ejection operation to be completed within the time range in which the circulation flow velocity of the printing head 110 is equal to or greater than the circulation flow velocity v1 at which the ink can be ejected. Note that, in the example illustrated in FIG. 11, the preliminary ejection is also executed from the nozzle in which the wiping operation is completed as illustrated in FIG. 9B.

In addition, as another example, in a case where the wiping and the preliminary ejection operation cannot be completed within the time range in which the circulation flow velocity of the printing head 110 is equal to or greater than the circulation flow velocity v1 at which the ink can be ejected from when the circulation driving stops, control to increase the ejection frequency in the preliminary ejection may be performed. With this, it is possible to shorten the required time for the preliminary ejection.

Moreover, it is possible to complete the wiping and the preliminary ejection operation within the time range in which the circulation flow velocity of the printing head 110 is equal to or greater than the circulation flow velocity v1 at which the ink can be ejected from when the circulation driving stops by combining the examples described above.

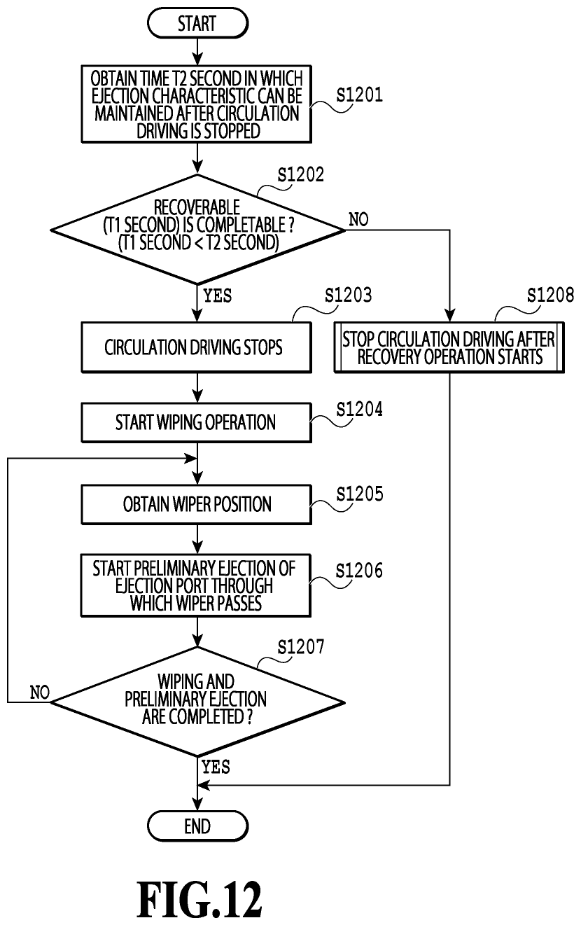

FIG. 12 illustrates a flowchart in control to execute the preliminary ejection from the nozzle in which the wiping operation is completed after the printing operation ends in the present embodiment. The processing illustrated in FIG. 12 is processing performed by the printing control unit 301 of the printing apparatus 101. That is, the CPU 302 of the printing control unit 301 reads out a program stored in the memory 303 or an external storage apparatus to be implemented by execution by the CPU 302. Note that, a part of or all the functions of steps in FIG. 12 may be implemented by hardware such as an ASIC or an electronic circuit. A sign “S” in the description of each processing means that it is a step in the flowchart (hereinafter, the same applies to a flowchart in the present specification). The processing illustrated in FIG. 12 is processing that is performed once it is determined that the recovery operation is necessary in a state during the circulation driving. In the present embodiment, a required time to complete both the recovery operation and preliminary ejection is described as T1. T1 may be a value obtained by actually performing the preliminary ejection from the nozzle in which the wiping is completed or a value derived by using a movement speed of the wiping and the time of the preliminary ejection.

In S1201, the printing control unit 301 obtains time T2 in which the printing can be performed without impairing the ejection characteristic from the timing when the circulation driving stops. In order to obtain the time T2, the printing control unit 301 obtains the circulation flow velocity v1 at which the ink can be ejected. The circulation flow velocity v1 at which the ink can be ejected is changed depending on a type of the ink, a printing operation mode, and the like. For example, in a case where the printing operation mode is a high image quality mode, the circulation flow velocity v1 at which the ink can be ejected is higher than that in a normal mode or a high-speed mode. In the high image quality mode, an ink amount per unit time that is ejected on the printing medium is greater than that in the normal mode or the high-speed mode. Therefore, a speed (circulation flow velocity) required to supply the fresh ink again to the nozzle is higher in the high image quality mode than that in the normal mode or the high-speed mode.

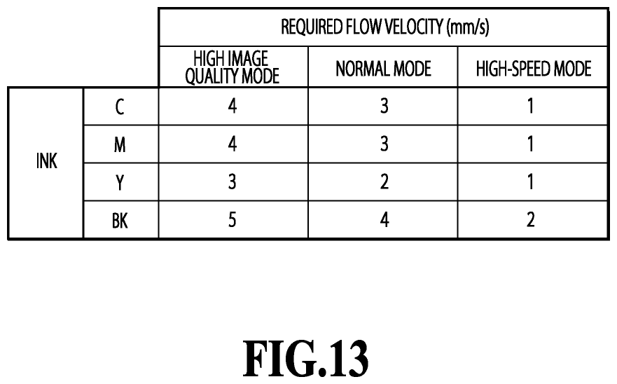

Thus, the circulation flow velocity v1 at which the ink can be ejected (hereinafter, also referred to as a required flow velocity) is changed based on the ink and the printing operation mode. Therefore, for example, the printing control unit 301 obtains a value of v1 from a required flow velocity table illustrated in FIG. 13.

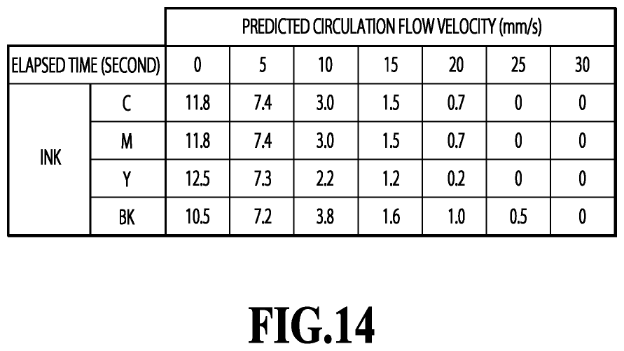

FIG. 13 is a diagram illustrating the required flow velocity table. FIG. 14 is a diagram illustrating a flow velocity prediction table. The required flow velocity table illustrated in FIG. 13 and the flow velocity prediction table illustrated in FIG. 14 are stored in the memory 303 or the external storage apparatus, for example.

For example, in a case where the ink to be determined is cyan (C), and the printing operation mode is the normal image quality mode, the printing control unit 301 refers to the table illustrated in FIG. 13 and determines that a flow velocity of 3 mm/s is required. Subsequently, the printing control unit 301 obtains the circulation flow velocity with respect to the elapsed time from when the circulation driving stops by using the flow velocity prediction table illustrated in FIG. 14. In the table in FIG. 14, the time in which the cyan ink maintains the flow velocity of 3 mm/s or greater after the circulation driving stops is T2 (cyan)=10 seconds.

In S1202, the printing control unit 301 compares T1 and T2 obtained (determined) as described above and determines whether it is possible to complete the recovery operation and the preliminary ejection operation. That is, the printing control unit 301 determines whether T1<T2. If it is T1<T2, even in a case where the circulation driving pump 408 is stopped, the ejection characteristic is not impaired until the recovery operation and the preliminary ejection operation end. Accordingly, the printing control unit 301 proceeds to S1203. On the other hand, if it is not T1<T2, in a case where the circulation driving pump 408 is stopped, the ejection characteristic is impaired until the recovery operation and the preliminary ejection operation end. Therefore, if it is not T1<T2, the printing control unit 301 proceeds to S1208. Note that, since T2 is different depending on the ink, the determination in S1202 is executed for each ink. That is, depending on the ink, there may be a case where the process proceeds to S1203 or a case where the process proceeds to S1208. Note that, the later-described wiping processing is processing in which the nozzle of each ink is not wiped individually but all the nozzles of the printing head 110 are wiped at once. That is, although the timing to stop the circulation driving pump 408 may be different depending on the ink, in the present embodiment, it is assumed that the time required until the recovery operation and the preliminary ejection operation end is common among the inks. Note that, the time required for the preliminary ejection operation may be different for each ink. In such a case, the time required until the recovery operation and the preliminary ejection operation end may be stored for each ink to be used as T1. That is, processing to obtain T1 for each ink may be applied.

In S1203, the printing control unit 301 stops the circulation driving by the circulation driving pump 408. Next, in S1204, the printing control unit 301 starts the wiping operation. Next, in S1205, the printing control unit 301 obtains a wiper position with respect to a nozzle position during the wiping operation. The obtainment of the wiper position can be derived from an elapsed time from when the wiping starts and a wiping speed, for example. Additionally, the printing control unit 301 can manage the wiper position based on count information that is obtained by counting slits by an encoder sensor corresponding to the recovery unit motor 206 that operates the wiper. That is, it is also possible to obtain the wiper position from sensor information. Note that, any method may be used as long as it is possible to obtain the wiper position with respect to the nozzle position during the wiping operation.

Next, in S1206, the printing control unit 301 determines the nozzle through which the first wiper 221 and the second wiper 222 pass as the nozzle in which the preliminary ejection starts. Then, the preliminary ejection is executed in the determined nozzle. That is, the printing control unit 301 causes the energy generation element 423 corresponding to the above-described determined nozzle (ejection port) to eject the ink.

Next, in S1207, the printing control unit 301 determines whether the wiping and the preliminary ejection are completed. If it is determined that the wiping and the preliminary ejection are completed, the printing control unit 301 ends the processing illustrated in FIG. 12. If it is determined that the wiping and the preliminary ejection are not completed, the printing control unit 301 returns to S1205 and repeats the processing. Thus, with the obtainment of the wiper position and the preliminary ejection operation in the nozzle through which the wiper passes being repeated, the preliminary ejection operation is started sequentially from the nozzle in which the wiping is completed. That is, the wiping and the preliminary ejection are operated in parallel.

Next, processing in a case where it is determined that it is not T1<T2 in S1202 is described. In S1208, the printing control unit 301 performs processing to stop the circulation driving after the recovery operation starts. Then, the printing control unit 301 ends the processing illustrated in FIG. 12.

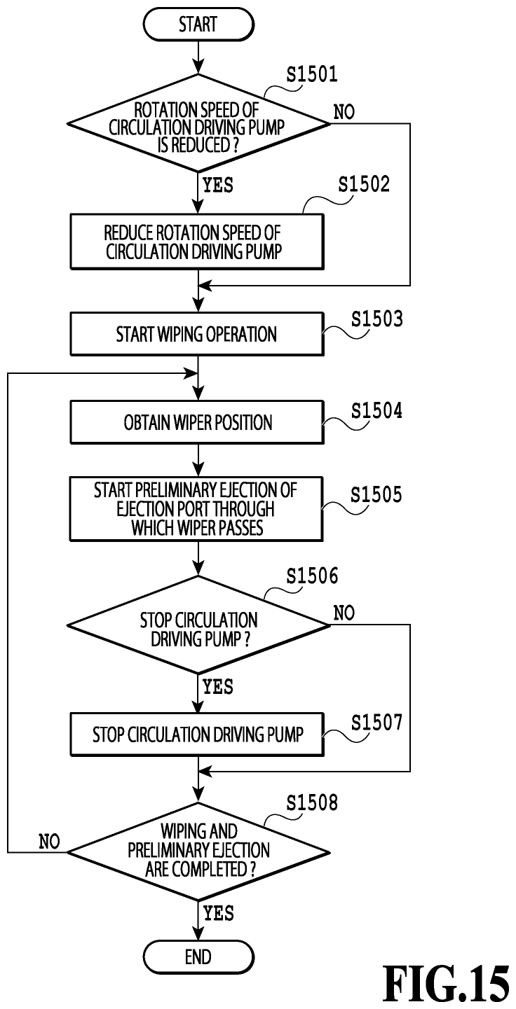

FIG. 15 is a flowchart illustrating details of the processing in S1208. In S1501, the printing control unit 301 determines whether to reduce the rotation speed of the circulation driving pump 408. The determination in S1501 may be performed based on previous setting contents or may be performed based on designation by the user. If it is determined to reduce the rotation speed of the circulation driving pump 408, the printing control unit 301 proceeds to S1502. In S1502, the printing control unit 301 reduces the rotation speed of the circulation driving pump 408. Then, the process proceeds to S1503. If it is determined not to reduce the rotation speed of the circulation driving pump 408, the printing control unit 301 proceeds to S1503.

The processing from S1503 to S1505 is the same as the processing from S1204 to S1206; for this reason, the description is omitted. In S1506, the printing control unit 301 determines whether to stop the circulation driving pump 408. For example, if it is determined that it is not T1<T2, the printing control unit 301 can specify the time that satisfies T1<T2 by adding a predetermined time to T2. In a case where the predetermined time has elapsed, the printing control unit 301 determines to stop the circulation driving pump 408. Additionally, likewise, the circulation operation is unnecessary while the printing is stopped also in a case where the rotation speed is reduced; therefore, the printing control unit 301 may determine to stop the circulation driving pump 408 in a case where it reaches the time that satisfies T1<T2 at the reduced rotation speed.

If it is determined to stop the circulation driving pump 408 in S1506, the process proceeds to S1507. In S1507, the printing control unit 301 stops the circulation driving pump 408. Then, the process proceeds to S1508. If it is determined not to stop the circulation driving pump 408 in S1506, the printing control unit 301 proceeds to S1508. The processing in S1508 is similar to the processing in S1207; for this reason, the description is omitted.

Note that, as described above, the wiping is performed commonly among the inks. Therefore, for example, even in a case where there are the ink that satisfies T1<T2 and the ink that does not satisfy T1<T2 coexist, the processing to start the wiping operation in S1204 and S1503 is the processing in the same timing. As a matter of course, as long as it is a mode in which each nozzle of the ink is wiped individually, the processing to start the wiping operation in S1204 and S1503 may not be the processing in the same timing. Additionally, as described above, processing in which the control to increase the ejection frequency in the preliminary ejection is combined with the flowchart illustrated in FIG. 12 or 15 may be applied.

As described above, according to the present embodiment, it is possible to suppress the foreign substance and the like from entering into the channel during the recovery operation. Additionally, it is possible to suppress the reduction of the productivity. That is, in the present embodiment, the wiping and the preliminary ejection operation are executed in parallel. With this, the preliminary ejection is performed from the nozzle in which the wiping is completed before the wiping of all the nozzles is completed, and thus it is possible to suppress the color-mixed ink or the foreign substance from entering into the channel during the recovery operation while suppressing the reduction of the productivity. Particularly, there is a tendency in a printing head with an elongated nozzle array that the time required for the wiping of all the nozzles is increased. With the parallel execution of the wiping and the preliminary ejection operation as the present embodiment, it is possible to suppress the reduction of the productivity.

Additionally, in the present embodiment, a configuration in which the wiping and the preliminary ejection operation are completed within the time range in which the circulation flow velocity of the printing head 110 is equal to or greater than the circulation flow velocity v1 at which the ink can be ejected from when the circulation driving of each ink stops is applied. Therefore, it is possible to suppress the invasion of the thickened ink, the foreign substance, and the color-mixed ink into the channel during the wiping while suppressing an effect on the printing image after the circulation driving stops.

### SECOND EMBODIMENT

In the present embodiment, an example in which a preliminary ejection amount is determined according to the circulation flow velocity at the time of executing the preliminary ejection in a case where the ink in the channel (in the pressure chamber) passing through the nozzle is circulated during the printing operation, and the recovery operation of the ejection port surface is executed after the printing operation ends is described. With this, it is possible to reduce an invasion range of the thickened ink, the foreign substance, and the color-mixed ink into the channel during the wiping and to make the discharging by the preliminary ejection easy. Note that, the basic configuration is similar to the example described in the first embodiment; for this reason, a different portion is mainly described.

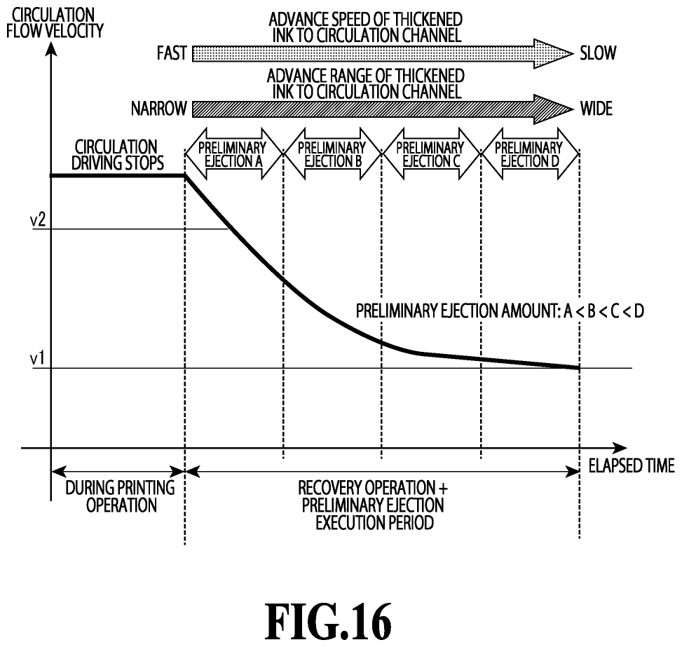

FIG. 16 is a diagram illustrating a secular change of the circulation flow velocity after the circulation driving pump is stopped. A horizontal axis indicates an elapsed time after the circulation driving pump is stopped. A vertical axis indicates the circulation flow velocity. In a case where the circulation driving is stopped after the printing operation of the image on the printing medium 103 is completed, immediately after the circulation flow velocity of the ink by the pump driving ceases, the pressure difference remains between the first pressure control chamber 406 and the second pressure control chamber 407. In addition, since the valve 412 in the inlet port of the second pressure control chamber 407 is opened, the ink keeps flowing continuously for a certain time in the channel between the pressure control chambers and the channel passing through the nozzle while the flow velocity of the ink slows down. In a case where the recovery operation of the ejection port surface is performed in this state, as described above, there is a possibility that the thickened ink, the foreign substance, and the color-mixed ink pushed in the nozzle may invade deep into the circulation channel.

In this case, the thickened ink, the foreign substance, and the color-mixed ink invading the inside of the nozzle have different advance ranges and different advance speeds into the channel depending on the circulation flow velocity. In FIG. 16, it is indicated that the faster the circulation flow velocity, the faster the advance speed of the thickened ink into the circulation channel and the narrower the advance range of the thickened ink from the nozzle. Additionally, it is indicated that the slower the circulation flow velocity, the slower the advance speed of the thickened ink and the wider the advance range of the thickened ink from the nozzle.

Note that, in general, the faster the flow velocity, the deeper the thickened ink flows downstream in the channel; for this reason, in this case, it is necessary to increase the preliminary ejection amount. However, in the example in FIG. 16, a transition of the flow velocity reduction after the circulation driving stops is illustrated. In this phase of the flow velocity reduction, it is possible to suppress the entire invasion by the thickened ink by determining the preliminary ejection amount based on the advance range to suppress the thickened ink from advancing to a wide range. The advance range and the required preliminary ejection amount have a correlation as illustrated in FIG. 16. Accordingly, in the present embodiment, in terms of the advance range, a configuration of a small preliminary ejection amount is applied since the advance range is small in a state in which the circulation flow velocity after the circulation driving stops is fast. Hereinafter, an example in which the preliminary ejection amount is determined according to the circulation flow velocity at the time of executing the preliminary ejection is described.

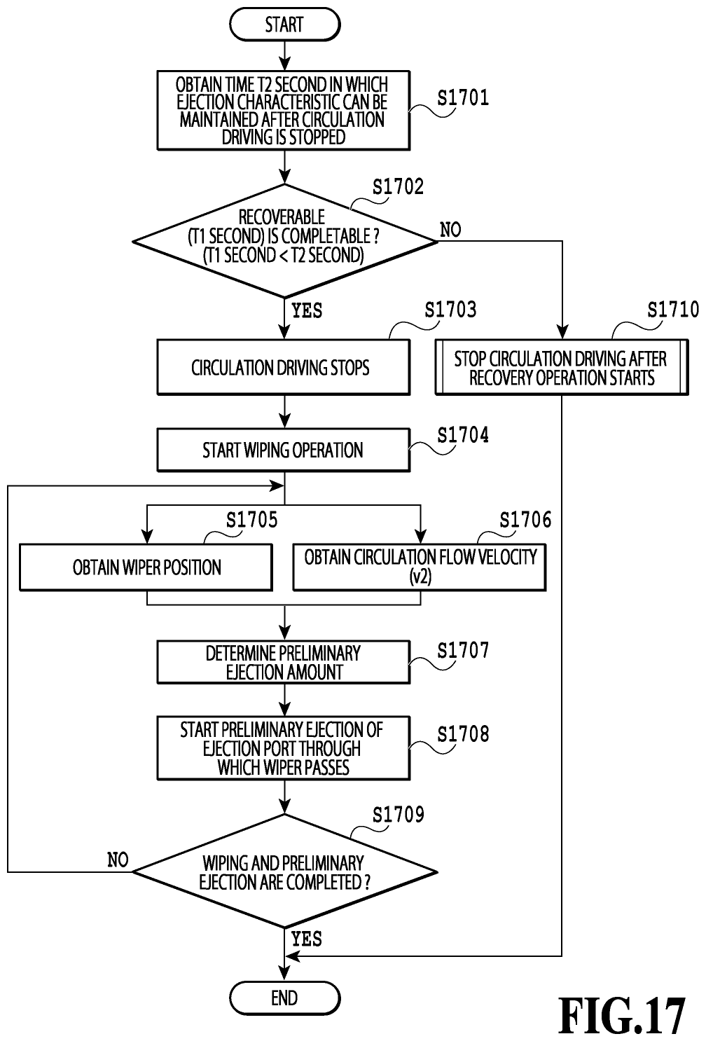

FIG. 17 is a diagram illustrating a flowchart in control to execute the preliminary ejection from the nozzle in which the wiping operation is completed after the printing operation ends in the present embodiment. As with the example described with reference to FIG. 12, the processing illustrated in FIG. 17 is the processing performed by the printing control unit 301 of the printing apparatus 101. Additionally, as with the example described with reference to FIG. 12, the processing illustrated in FIG. 17 is the processing once it is determined that the recovery operation is necessary in a state during the circulation driving. In the present embodiment, the required time to complete both the recovery operation and preliminary ejection is described as T1.

The processing from S1701 to S1704 is similar to the processing from S1201 to S1204 in FIG. 12. That is, if it is T1<T2, since the ejection characteristic is not impaired until the printing operation ends even in a case where the circulation driving pump 408 is stopped, the printing control unit 301 stops the circulation driving by the circulation driving pump 408 in S1703 and starts the wiping operation in S1704.

Next, as with the example described in the first embodiment, in S1705, the printing control unit 301 obtains the wiper position with respect to the nozzle position during the wiping operation. Note that, the method of obtaining the wiper position is similar to the example described in the first embodiment. In the present embodiment, in parallel with the processing in S1705, in S1706, the printing control unit 301 obtains a current circulation flow velocity v2. It is possible to derive the current circulation flow velocity v2 based on the required flow velocity table and the prediction circulation flow velocity table for the elapsed time from when the circulation stops that are illustrated in FIGS. 13 and 14.

Next, in S1707, the printing control unit 301 determines the preliminary ejection amount according to the current circulation flow velocity v2 obtained in S1706. Subsequently, in S1708, the printing control unit 301 determines the nozzle (the ejection port) through which the first wiper 221 and the second wiper 222 pass as the nozzle in which the preliminary ejection starts, and the preliminary ejection starts in the nozzle. In the preliminary ejection performed in S1708, the preliminary ejection amount is a preliminary ejection amount having a relationship illustrated in FIG. 16. At the circulation flow velocity v2 illustrated in FIG. 16, it is indicated that the preliminary ejection amount is A. In reality, a table defining the number of times of ejection by each nozzle corresponding to A to D is stored in advance in the memory 303, and the printing control unit 301 may control the preliminary ejection amount with reference to this table. Additionally, the required preliminary ejection amount is different depending on the ink, the configuration of the printing head, and the like. Therefore, for example, it is possible to determine the preliminary ejection amount defined in the table by confirming the preliminary ejection amount that can discharge the thickened ink, the foreign substance, and the color-mixed ink invading the circulation channel by the wiping. Note that, as a method of confirming whether the thickened ink, the foreign substance, and the color-mixed ink are discharged by the preliminary ejection, for example, whether the image printed on the printing medium has a desired density and tonality may be confirmed.

S1709 is the processing similar to that in S1207; for this reason, the description is omitted. Additionally, if it is determined that it is T1<T2 in S1702, the printing control unit 301 proceeds to S1710.

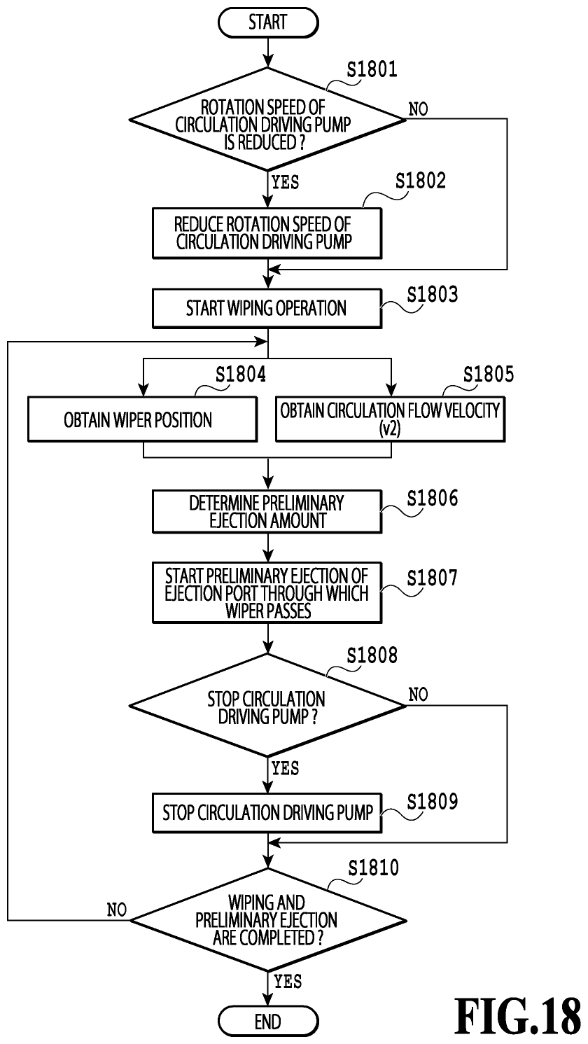

FIG. 18 is a flowchart illustrating details of S1710. The processing from S1801 to S1803 is similar to the processing from S1501 to S1503 in FIG. 15. Additionally, the processing from S1804 to S1807 is similar to the processing from S1705 to S1708. Moreover, the processing from S1808 to S1810 is similar to the processing from S1506 to S1508. Thus, in a case where the driving of the circulation driving pump 408 is stopped after the recovery operation starts, the processing to determine the preliminary ejection amount based on the circulation flow velocity at the time of performing the preliminary ejection is also performed.

As described above, according to the present embodiment, with the preliminary ejection amount being determined according to the circulation flow velocity at the time of executing the preliminary ejection, it is possible to reduce the invasion range by the thickened ink, the foreign substance, and the color-mixed ink into the channel during the wiping. In addition, it is possible to make the discharging by the preliminary ejection easy while reducing the waste ink amount required for the preliminary ejection.

### THIRD EMBODIMENT

In the first embodiment and the second embodiment, an example of control to determine the nozzle in which the wiping operation is completed and execute the preliminary ejection in the nozzle is described. In the present embodiment, an example in which the completion of the wiping is determined by an area unit, and the preliminary ejection is executed in the nozzle in the area is described. The basic configuration and the like are similar to the example described in the first embodiment or the second embodiment; for this reason, the description is omitted.

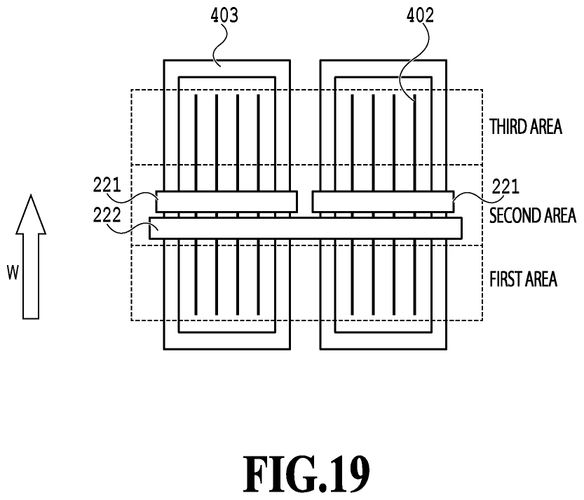

FIG. 19 is a diagram illustrating an example of a wiping area. Depending on the type of the printing head 110, it is difficult in some cases to control the starting of the preliminary ejection in a unit of the nozzle through which the first wiper 221 and the second wiper 222 pass. In the present embodiment, in such a case, all the nozzles of the ejection port surface are divided into areas in a predetermined nozzle unit. In the example in FIG. 19, an example in which the nozzles are divided into three areas, which are a first area, a second area, and a third area, is illustrated. For example, in a timing when the first wiper 221 and the second wiper 222 pass through the first area and start the wiping in the second area, the printing control unit 301 executes the preliminary ejection in the nozzle in the first area. Note that, although it is described by using an example in which the areas are divided into three in the present embodiment, the areas may be divided into any number of areas as long as it is two or more.

As described above, according to the present embodiment, even in a case where it is impossible to manage the completion of the wiping for each nozzle, it is possible to suppress the color-mixed ink or the foreign substance from entering into the channel during the recovery operation while suppressing the reduction of the productivity.

### FOURTH EMBODIMENT

In the second embodiment, the example in which the preliminary ejection amount is controlled according to the circulation flow velocity at the time of executing the preliminary ejection is described. In the present embodiment, an example in which the preliminary ejection amount for each nozzle is controlled according to a channel configuration of the nozzle is described. The basic configuration is similar to the example described in the first embodiment; for this reason, a different point is mainly described. Additionally, the present embodiment may be combined with the example described in the second embodiment or the third embodiment.

In the example described in FIG. 7, the inlet port 421 to flow the ink into the ejection port 402 and the pressure chamber 424 and the outlet port 422 to flow the ink out of the ejection port 402 and the pressure chamber 424 are formed on two sides of the nozzle. The inlet port 421 and the outlet port 422 also form a channel. In the example in FIG. 7, the inlet port 421 and the outlet port 422 are each arranged for two nozzles. However, for example, in a case where the inlet port 421 and the outlet port 422 are each arranged for more than two nozzles, it is necessary for the nozzle close to the outlet port 422 to discharge also the thickened ink and the like invading the collection channel 432 connected to the outlet port 422 in the preliminary ejection.

In the present embodiment, an example in which the invasion range of the thickened ink, the foreign substance, and the color-mixed ink into the channel during the wiping into the circulation channel is reduced by setting a greater preliminary ejection amount as the nozzle is closer to the outlet port 422.

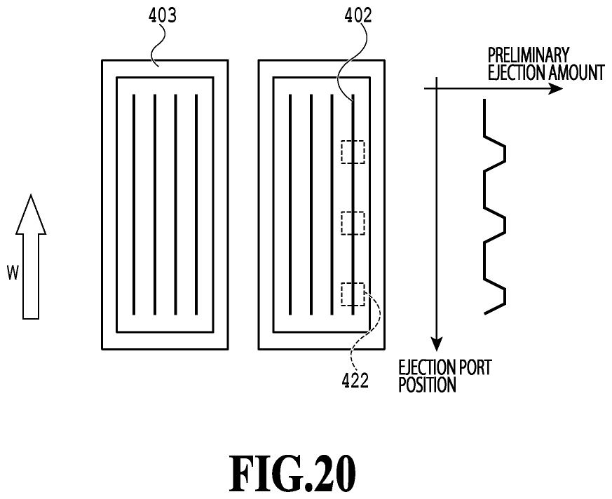

FIG. 20 is a diagram describing control of the preliminary ejection amount of each nozzle according to the channel configuration of the nozzle in the present embodiment. In FIG. 20, an example in which three outlet ports 422 are provided for the entire length of an array portion in which the ejection ports 402 are arrayed. In addition, in FIG. 20, it is illustrated that the preliminary ejection amount is controlled to be increased as the nozzle is closer to the outlet port 422.

As described above, according to the present embodiment, it is possible to reduce the invasion range of the thickened ink, the foreign substance, and the color-mixed ink into the channel during the wiping, to reduce the waste ink amount required for the preliminary ejection, and to make the discharging by the preliminary ejection easy.

Note that, in the present embodiment, as the example described in the third embodiment, the area in which the preliminary ejection is executed may also be set according to the channel configuration. For example, an area according to the number of the outlet ports 422 arranged in correspondence with the number of the ejection ports 402 (the nozzles) may be set, and the preliminary ejection may be started in a unit of the area in which the wiping is completed.

### OTHER EMBODIMENTS

Additionally, although a mode in which the circulation driving pump 408 is included in the printing head 110 is described as an example in the above-described embodiments, a mode in which the circulation driving pump is provided outside the printing head, that is, on a main body side may be applied. In any mode, in a case where a predetermined time is required until the circulation in the circulation channel is stopped after the driving of the circulation driving pump is stopped, the above-described embodiments are useful.

Moreover, although an example in which the ink still flows after the circulation driving pump 408 is stopped due to the pressure difference between the two pressure control chambers is described in the above-described embodiments, it is not limited to this example. As long as it is a mode in which the movement of the ink is not stopped immediately after the circulation driving pump 408 is stopped, and the ink can flow, the above-described embodiments are applicable to any mode.

Furthermore, as an example of the recovery operation, although the wiping operation using the first wiper 221 and the second wiper 222 is described as an example in the above-described embodiments, the recovery operation is not limited to this example. For example, a recovery operation in which the wiping is performed with sucking by using a suction wiper may be applied. In addition, as long as it is a mode in which the recovery operation is performed in a longitudinal direction of the printing head, any recovery operation may be applied.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-000169, filed Jan. 4, 2024, which is hereby incorporated by reference wherein in its entirety.

What is claimed is:

1. A liquid ejection apparatus, comprising:
a liquid ejection head including an ejection port configured to eject a liquid and a pressure chamber communicating with the ejection port;
a circulation unit configured to circulate the liquid in the liquid ejection head so as to pass through the pressure chamber;
a recovery unit configured to perform a recovery operation of the liquid ejection head at a circulation flow velocity slower than a circulation flow velocity of the circulation unit in a case where the liquid ejection head prints an image on a printing medium; and
a control unit configured to control preliminary ejection to eject the liquid that is not used for the printing from the ejection port in parallel with the recovery operation by the recovery unit.

2. The liquid ejection apparatus according to claim 1, wherein
the control unit performs the preliminary ejection from the ejection port in which the recovery operation is completed.

3. The liquid ejection apparatus according to claim 1, wherein
after a printing operation on the printing medium is completed, the control unit executes the recovery operation after the circulation unit is stopped.

4. The liquid ejection apparatus according to claim 1, wherein
after a printing operation on the printing medium is completed, the control unit executes the recovery operation while reducing a rotation speed of a pump in the circulation unit.

5. The liquid ejection apparatus according to claim 3, wherein
the control unit completes the recovery operation and the preliminary ejection within a time range in which the circulation flow velocity is equal to or greater than a circulation flow velocity at which the liquid ejection head can eject the liquid.

6. The liquid ejection apparatus according to claim 3, wherein
in a case where the recovery operation and the preliminary ejection are not completed within a time range in which the circulation flow velocity is equal to or greater than a circulation flow velocity at which the liquid ejection head can eject the liquid, the control unit stops the circulation unit after the printing operation on the printing medium is completed and after the recovery operation is started.

7. The liquid ejection apparatus according to claim 3, wherein
in a case where the preliminary ejection is not completed within a time range in which the circulation flow velocity is equal to or greater than a circulation flow velocity at which the liquid ejection head can eject the liquid, the control unit increases an ejection frequency of the preliminary ejection. 8 The liquid ejection apparatus according to claim 1, further comprising:
a derivation unit configured to derive the circulation flow velocity, wherein
the control unit determines an amount of the preliminary ejection based on the circulation flow velocity derived by the derivation unit at time of executing the preliminary ejection.

9. The liquid ejection apparatus according to claim 8, wherein
the control unit reduces the amount of the preliminary ejection more as the circulation flow velocity after the circulation unit is stopped is faster.

10. The liquid ejection apparatus according to claim 1, wherein
the control unit performs the control for each area formed of a predetermined number of ejection ports.

11. The liquid ejection apparatus according to claim 1, wherein
the liquid ejection head includes an inlet port through which the liquid flows into the ejection port and an outlet port through which the liquid flows out through the ejection port, and
based on a position of the outlet port and a position of the ejection port, the control unit determines an amount of the preliminary ejection.

12. The liquid ejection apparatus according to claim 11, wherein
the control unit increases an amount of the preliminary ejection more as the ejection port is closer to the position of the outlet port.

13. The liquid ejection apparatus according to claim 1, wherein
the liquid ejection head includes a first pressure control chamber connected with a first channel communicating with the ejection port and a second pressure control chamber connected with a second channel communicating with the ejection port, and
the liquid is circulated to pass through the ejection port according to a pressure difference between the first pressure control chamber and the second pressure control chamber.

14. The liquid ejection apparatus according to claim 1, wherein
the recovery unit is a wiper configured to wipe an ejection port surface in which the ejection port is provided, and
the recovery operation is an operation to wipe the ejection port surface.

15. A method of controlling a liquid ejection apparatus including
a liquid ejection head including an ejection port configured to eject a liquid and a pressure chamber communicating with the ejection port,
a circulation unit configured to circulate the liquid in the liquid ejection head so as to pass through the pressure chamber, and
a recovery unit configured to perform a recovery operation of the liquid ejection head at a circulation flow velocity slower than a circulation flow velocity of the circulation unit in a case where the liquid ejection head prints an image on a printing medium, the method comprising:
executing the recovery operation by the recovery unit; and
controlling preliminary ejection to eject the liquid that is not used for the printing from the ejection port in parallel with the recovery operation by the recovery unit.
